(19) United States
(12) Patent Application Publication
(10) Pub. No.: US 2026/0154037 A1
(43) Pub. Date: Jun. 4, 2026

(54) CIRCUIT STRUCTURE ADAPTED TO SWITCH BETWEEN INVERSE SQUARE ROOT OPERATION AND RECIPROCAL OPERATION

(71) Applicant: National Yang Ming Chiao Tung University, Hsinchu City (TW)

(72) Inventors: Juinn-Dar HUANG, Zhubei City (TW); Jye-En WU, Taipei City (TW); Ting-Wei HU, Luodong Township (TW)

(21) Appl. No.: 19/058,914

(22) Filed: Feb. 20, 2025

(30) Foreign Application Priority Data
Dec. 4, 2024 (TW) 113146990

(51) Int. Cl. G06F 7/76; G06F 7/552; G06F 7/72

(52) U.S. Cl. CPC G06F 7/76; G06F 7/552; G06F 7/726

(57) ABSTRACT

A circuit structure is adapted to switch between inverse square root (ISR) operation and reciprocal operation, and includes a multiplexer module to selectively provide ISR operation constant(s) or reciprocal operation constant(s), and an operation circuit configured to selectively use the ISR operation constant(s) to perform ISR operation or use the reciprocal operation constant(s) to perform reciprocal operation on a positive integer. The operation circuit includes at least one arithmetic unit that is used in both of the ISR operation and the reciprocal operation.

### CROSS-REFERENCE TO RELATED APPLICATION

This application claims priority to Taiwanese Invention Patent Application No. 113146990, filed on Dec. 4, 2024, the entire disclosure of which is incorporated by reference herein.

### FIELD

The disclosure relates to a circuit structure, and more particularly to a circuit structure adapted to switch between inverse square root (ISR) operation and reciprocal operation.

### BACKGROUND

With the rapid development of artificial intelligence (AI) technology, various applications have been gradually integrated into daily life. Whether in convolutional neural networks (CNNs) or transformer models, normalization operations frequently require ISR computations. Additionally, division operations are necessary when calculating softmax or other nonlinear functions. These operations are critical for achieving precise model inference. However, as neural network models become increasingly complex, the growing number of parameters and computational demands make it more challenging to deploy large models on resource-constrained edge devices.

### SUMMARY

Therefore, an object of the disclosure is to provide a shared hardware architecture for both reciprocal and inverse square root computations.

According to the disclosure, a circuit structure adapted to switch between ISR operation and reciprocal operation is provided to include a register module, a multiplexer module, and an operation circuit. The register module stores at least one ISR operation constant and at least one reciprocal operation constant. The multiplexer module is electrically connected to the register module to receive the at least one ISR operation constant and the at least one reciprocal operation constant, is disposed to receive a mode select signal that indicates one of the ISR operation and the reciprocal operation, and is configured to deliver a multiplexer constant output. The multiplexer constant output is the at least one ISR operation constant in response to the mode select signal indicating the ISR operation, and is the at least one reciprocal operation constant in response to the mode select signal indicating the reciprocal operation. The operation circuit is disposed to receive a positive integer and the mode select signal, and is electrically connected to the multiplexer module for receiving the multiplexer constant output. The operation circuit is configured to, in response to the mode select signal indicating the ISR operation, perform a first set of elementary arithmetic operations on the positive integer using the multiplexer constant output that is the at least one ISR operation constant, thereby obtaining an estimated value of an inverse square root of the positive integer. The operation circuit is configured to, in response to the mode select signal indicating the reciprocal operation, perform a second set of elementary arithmetic operations on the positive integer using the multiplexer constant output that is the at least one reciprocal operation constant, thereby outputting an estimated value of a reciprocal of the positive integer. The operation circuit includes at least one arithmetic unit that is used in both of the first set of elementary arithmetic operations and the second set of elementary arithmetic operations.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic diagram illustrating a 32-bit floating-point format.

FIG. 2 is a block diagram illustrating a first embodiment of a circuit structure adapted to switch between ISR operation and reciprocal operation according to this disclosure.

FIG. 3 is a block diagram illustrating a second embodiment of a circuit structure adapted to switch between ISR operation and reciprocal operation according to this disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

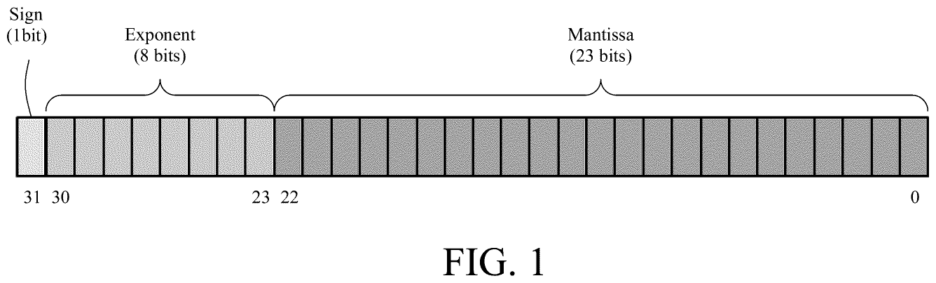

Referring to FIG. 1, a 32-bit floating-point format is shown to include twenty-three mantissa bits (from bit 0 to bit 22, also referred to as fraction bits), eight exponent bits (from bit 23 to bit 30), and one sign bit (bit 31). The mantissa bits are used to represent a fractional part of a binary number, which is actually composed of a hidden leading 1 followed by the mantissa bits. The exponent bits are used to represent the magnitude of the exponent. In this embodiment, the exponent is represented using an exponent bias of 127, meaning that 127 in binary represents an exponent of 0. The sign bit is used to indicate the sign of the number. In general, “0” represents a positive number, and “1” represents a negative number. Since the input for the ISR operation must be positive, the sign bit is fixed to 0 in this embodiment.

When a positive integer x is to be converted into the floating-point format, the positive integer x can first be represented in binary scientific notation (1+mₓ)₂×2^{e}ₓ, where mₓ represents a binary fraction greater than or equal to 0 and smaller than 1, and eₓ is an integer in decimal. The mantissa bits Mₓ of the positive integer x in the floating-point format can be obtained according to

$${M}_{x} = {m}_{x} L , \qquad ( 1 )$$

where L is a constant equal to 2ⁿ, and n is a number of the mantissa bits in the floating-point format, which is 23 in this embodiment. The exponent bits Eₓ of the positive integer x in the floating-point format can be obtained according to

$${E}_{x} = ( {e}_{x} + B ) , \qquad ( 2 )$$

where B represents the exponent bias, which is 127 in this embodiment. As a result, the positive integer x is converted into a floating-point number Iₓ according to

$${I}_{x} = ( {E}_{x} L + {M}_{x} ) \qquad ( 3 )$$

by interpreting the floating-point number Iₓ from an integer perspective.

Taking the positive integer x=144 as an example, (144)₁₀=(10010000)₂=(1.001)₂×2⁷, so mₓ=(0.001)₂ and eₓ=7. Following equations (1) and (2), it can be derived that

$${M}_{x} = {m}_{x} L = {( 0.001 )}_{2} \times {2}^{23} = {( 00100000000000000000000 )}_{2} , and$$

$${E}_{x} = ( {e}_{x} + B ) = ( 7 + 127 ) = 134 = {( 10000110 )}_{2} ,$$

so the floating-point number Iₓ, which is the positive integer x=144 in the floating-point format in this example, is obtained by

$${I}_{x} = ( {E}_{x} L + {M}_{x} ) = {( 01000011000100000000000000000000 )}_{2} .$$

To calculate an inverse square root of the positive integer x we solve for y in

$$y = \frac{1}{\sqrt{x}} , \qquad ( 4 )$$

equation (4) can be first converted into

$${log}_{2} y = - \frac{1}{2} {log}_{2} x . \qquad ( 5 )$$

If x and y are expressed in binary scientific notation (i.e., x=(1+mₓ)₂×2^{e}ₓ, and y=(1+m_{y})₂×2^{e}_{y}), the following may be obtained

$${log}_{2} ( 1 + {m}_{y} ) + {e}_{y} = - \frac{1}{2} {log}_{2} ( 1 + {m}_{x} ) - \frac{1}{2} {e}_{x} . \qquad ( 6 )$$

Because each of mₓ and m_{y} is greater than or equal to 0 and smaller than 1, an approximation of the complex logarithmic calculation can be made according to

$${log}_{2} ( 1 + h ) \approx h + σ , \qquad ( 7 )$$

where h represents a number greater than or equal to 0 and smaller than 1, and σ is an approximation parameter equaling 0.0450465. By directly applying this approximate statement to equation 6, the following may be obtained

$${m}_{y} + σ + {e}_{y} = - \frac{1}{2} {m}_{x} - \frac{1}{2} σ - \frac{1}{2} {e}_{x} . \qquad ( 8 )$$

Then, by multiplying both sides of equation (8) by the constant L and according to equations (1) and (2), mₓ, m_{y}, eₓ and e_{y} can be transformed respectively into Mₓ, M_{y}, Eₓ and E_{y}, and equation (8) can be rewritten as

$${M}_{y} + σ L + ( {E}_{y} - B ) L = - \frac{1}{2} {M}_{x} - \frac{1}{2} σ L - \frac{1}{2} ( {E}_{x} - B ) L , \qquad ( 9 )$$

and the following may be obtained

$${M}_{y} + {E}_{y} L = \frac{3}{2} ( B - σ ) L - \frac{1}{2} ( {M}_{x} + {E}_{x} L ) . \qquad ( 10 )$$

According to equation (3), an approximation of the inverse square root of the positive number x in the floating-point format (denoted by I_{y} herein) is derivable and can be calculated using a set of elementary arithmetic operations in

$${I}_{y} = \frac{3}{2} ( B - σ ) L - \frac{1}{2} {I}_{x} , \qquad ( 11 )$$

noting that both of Iₓ and I_{y} are interpreted from the integer perspective herein. Since B, σ and L are constants, equation (11) can be written as

$${I}_{y} = {a}_{1} - \frac{1}{2} {I}_{x} , \qquad ( 12 )$$

where a₁ is a constant (referred to as a first ISR operation constant hereinafter) equaling 3/2(B−σ)L.

To calculate a reciprocal of the positive integer x, we solve for y in

$$y = \frac{1}{x} , \qquad ( 13 )$$

the equation (13) can be first transformed into

$${log}_{2} y = - {log}_{2} x . \qquad ( 14 )$$

If x and y are expressed in binary scientific notation, we may obtain the following

$${log}_{2} ( 1 + {m}_{y} ) + {e}_{y} = - {log}_{2} ( 1 + {m}_{x} ) - {e}_{x} . \qquad ( 15 )$$

By directly applying approximate statement (7) to equation (15), the following may be obtained

$${m}_{y} + σ + {e}_{y} = - {m}_{x} - σ - {e}_{x} . \qquad ( 16 )$$

Then, by multiplying both sides of equation (16) by the constant L and according to equations (1) and (2), mₓ, m_{y}, eₓ and e_{y} can be transformed respectively into Mₓ, M_{y}, Eₓ and E_{y}, and equation (16) can be rewritten as

$${M}_{y} + σ L + ( {E}_{y} - B ) L = - {M}_{x} - σ L - ( {E}_{x} - B ) L , \qquad ( 17 )$$

and the following may be obtained

$${M}_{y} + {E}_{y} L = 2 ( B - σ ) L - ( {M}_{x} + {E}_{x} L ) . \qquad ( 18 )$$

According to equation (3), an approximation of the reciprocal of the positive number x in the floating-point format (denoted by I_{y} herein) may be derived and can be calculated using a set of elementary arithmetic operations in

$${I}_{y} = 2 ( B - σ ) L - {I}_{x} , \qquad ( 19 )$$

noting that both of Iₓ and I_{y} are interpreted from the integer perspective herein. Since B, σ and L are constants, equation (19) can be written as

$${I}_{y} = {a}_{2} - {I}_{x} , \qquad ( 20 )$$

where a₂ is a constant (referred to as a first reciprocal operation constant hereinafter) equaling 2(B−σ)L.

It can be observed that equations (12) and (20) have similar forms, as both involve subtracting a number associated with Iₓ from a constant. Therefore, equations (12) and (20) can be implemented using a shared hardware architecture.

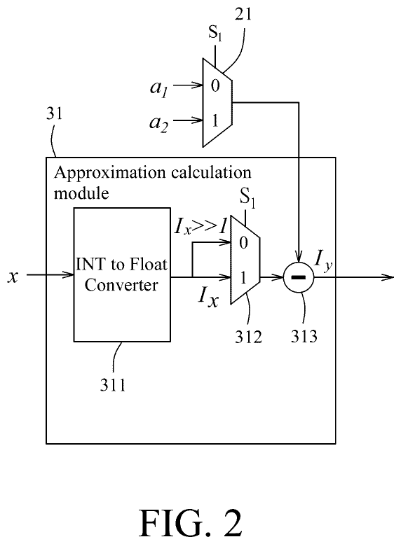

Referring to FIG. 2, a first embodiment of a circuit structure adapted to switch between ISR operation and reciprocal operation according to this disclosure is shown to include a constant-select multiplexer 21 and an approximation calculation module 31. The constant-select multiplexer 21 is disposed to receive the first ISR operation constant a₁ and the first reciprocal operation constant a₂ (e.g., from a register or the like, not shown), and a mode select signal S₁ (e.g., from a controller, a processor, or the like, not shown) that indicates one of ISR operation and reciprocal operation. In this embodiment, the mode select signal S₁ indicates the ISR operation when at a logic level of “0”, and indicates the reciprocal operation when at a logic level of “1”, but this disclosure is not limited in this respect. The constant-select multiplexer 21 is configured to output the first ISR operation constant a₁ as a first output constant in response to the mode select signal S₁ indicating the ISR operation, and to output the first reciprocal operation constant a₂ as the first output constant in response to the mode select signal S₁ indicating the reciprocal operation.

The approximation calculation module 31 includes an integer to floating-point converter 311, a first operation-switching multiplexer 312, and a subtractor 313. The integer to floating-point converter 311 receives the positive integer x, and converts the positive integer x into the floating-point format, thereby obtaining a floating-point number Iₓ. The first operation-switching multiplexer 312 receives the mode select signal S₁, and is connected to the integer to floating-point converter 311 to receive the floating-point number Iₓ and a binary integer number, and is configured to output the binary integer number as a first multiplexer output in response to the mode select signal S₁ indicating the ISR operation, and to output the floating-point number Iₓ as the first multiplexer output in response to the mode select signal S₁ indicating the reciprocal operation. In this embodiment, the binary integer number equals ½Iₓ (see equation (12)), which can be deemed as a binary value of right-shifting the floating-point number Iₓ by one bit, denoted using Iₓ>>1. In practice, the binary integer number may be obtained in various ways, such as using a shifter register, or simply by discarding the least significant bit (LSB) of the floating-point number Iₓ, and this disclosure is not limited in this respect. The subtractor 313 is connected to the first operation-switching multiplexer 312 to receive the first multiplexer output, is connected to the constant-select multiplexer 21 to receive the first output constant, and is configured to subtract the first multiplexer output from the first output constant using fixed-point arithmetic, thereby obtaining a first subtractor output I_{y}. It is noted that, when the first multiplexer output is the floating-point number Iₓ (i.e., when the mode select signal S₁ indicates the reciprocal operation), the subtractor 313 performs the subtraction by treating the floating-point number Iₓ as if the floating-point number Iₓ were a binary integer. As a result, the first subtractor output I_{y} is an approximation (or an estimated value) of the inverse root square of the positive integer x in the floating-point format when the mode select signal S₁ indicates the ISR operation, and is an approximation (or an estimated value) of the reciprocal of the positive integer x in the floating-point format when the mode select signal S₁ indicates the reciprocal operation.

In the first embodiment, the subtractor 313 is used in both of the ISR operation and the reciprocal operation, thereby achieving high area efficiency of the circuit structure.

In some applications, higher accuracy is required when calculating the inverse squire root or reciprocal of a positive integer. In these situations, Newton's method (also referred to as Newton's iterative method) can be used to refine the approximation obtained using the first embodiment, thereby further approaching the real value of the inverse squire root or reciprocal of the positive integer.

In a case where the approximation of the inverse square root of the positive integer x is to be refined, a function is first designed as

$$f ( y ) = x - \frac{1}{{y}^{2}} , \qquad ( 21 )$$

where y represents an estimated value of the inverse square root of the positive integer x. According to Newton's method:

$${y}_{n + 1} = {y}_{n} - \frac{f ( {y}_{n} )}{{f}^{′} ( {y}_{n} )} ,$$

the estimated value y can be refined into a set of elementary arithmetic operations as

$${y}_{n + 1} = {y}_{n} ( \frac{3}{2} - \frac{1}{2} {xy}_{n}^{2} ) , \qquad ( 22 )$$

where yₙ represents an estimated value of the inverse square root of the positive integer x obtained in an n^{th} iteration of Newton's method, and Yₙ₊₁ represents an estimated value of the inverse square root of the positive integer x obtained in an (n+1)^{th} iteration of Newton's method, which is based on the immediately previous estimated value yₙ. Defining a constant b₁ (referred to as a second ISR operation constant hereinafter) that equals 3/2 and a constant c₁ (referred to as a third ISR operation constant hereinafter) that equals ½, equation (22) can be rewritten as

$${y}_{n + 1} = {y}_{n} ( {b}_{1} - {c}_{1} {xy}_{n}^{2} ) \qquad ( 23 )$$

In a case where the approximation of the reciprocal of the positive integer x is to be refined, a function is first designed as

$$f ( y ) = x - \frac{1}{y} \qquad ( 24 )$$

where y represents an estimated value of the reciprocal of the positive integer x. According to Newton's method, the estimated value y can be refined into a set of elementary arithmetic operations as

$${y}_{n + 1} = {y}_{n} ( 2 - {xy}_{n} ) \qquad ( 25 )$$

where yₙ represents an estimated value of the reciprocal of the positive integer x obtained in an n^{th} iteration of Newton's method, and Yₙ₊₁ represents an estimated value of the reciprocal of the positive integer x obtained in an (n+1)^{th} iteration of Newton's method, which is based on the immediately previous estimated value yₙ. Defining a constant b₂ (referred to as a second reciprocal operation constant hereinafter) that equals 2 and a constant c₂ (referred to as a third reciprocal operation constant hereinafter) that equals 1, equation (25) can be rewritten as

$${y}_{n + 1} = {y}_{n} ( {b}_{2} - {c}_{2} {xy}_{n} ) \qquad ( 26 )$$

It can be observed that equations (23) and (26) have similar forms, as both involve several multiplications and a subtraction. Therefore, equations (23) and (26) can be implemented using a shared hardware architecture.

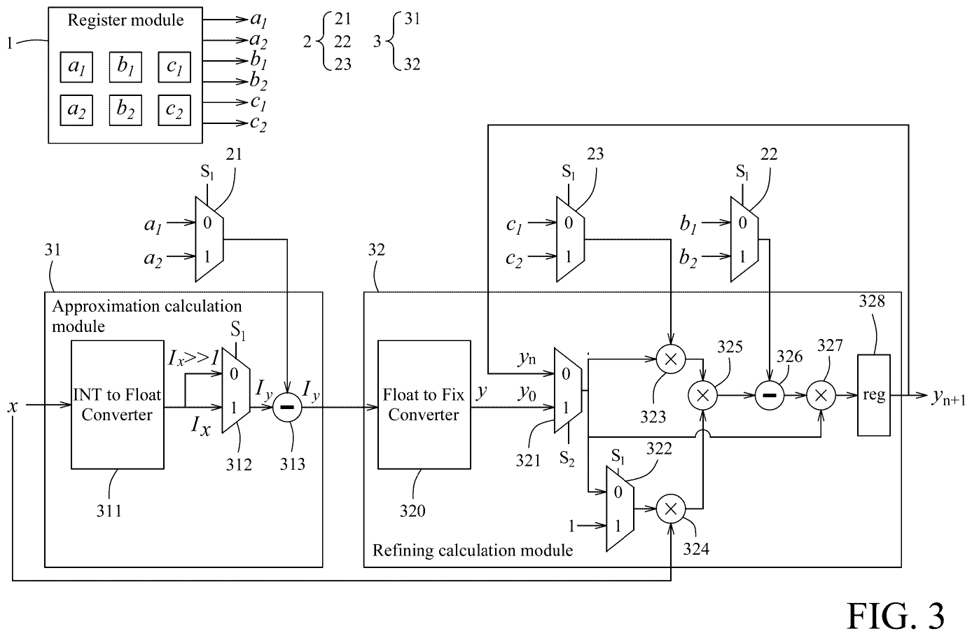

Referring to FIG. 3, a second embodiment of a circuit structure adapted to switch between ISR operation and reciprocal operation according to this disclosure is shown. The second embodiment takes the approximation generated in the first embodiment as an initial estimated value of the inverse square root or reciprocal of the positive integer x (denoted as y₀) and performs Newton's method, and includes, in addition to the aforesaid constant-select multiplexer 21 (referred to as a first constant-select multiplexer 21 hereinafter) and approximation calculation module 31, a second constant-select multiplexer 22, a third constant-select multiplexer 23, and a refining calculation module 32. In this embodiment, the first to third constant-select multiplexer 21-23 are collectively referred to as a multiplexer module 2, and the approximation calculation module 31 and the refining calculation module 32 are collectively referred to as an operation circuit 3. FIG. 3 further illustrates a register module 1 that stores the first to third ISR operation constants a₁, b₁, c₁ and the first to third reciprocal operation constants a₂, b₂, c₂.

The second constant-select multiplexer 22 receives the mode select signal S₁, and is connected to the register module 1 to receive the second ISR operation constant b₁ and the second reciprocal operation constant b₂. The second constant-select multiplexer 22 is configured to output the second ISR operation constant b₁ as a second output constant in response to the mode select signal S₁ indicating the ISR operation, and to output the second reciprocal operation constant b₂ as the second output constant in response to the mode select signal S₁ indicating the reciprocal operation.

The third constant-select multiplexer 23 receives the mode select signal S₁, and is connected to the register module 1 to receive the third ISR operation constant c₁ and the third reciprocal operation constant c₂. The third constant-select multiplexer 23 is configured to output the third ISR operation constant c₁ as a third output constant in response to the mode select signal S₁ indicating the ISR operation, and to output the third reciprocal operation constant c₂ as the third output constant in response to the mode select signal S₁ indicating the reciprocal operation.

The refining calculation module 32 includes a floating-point to fixed-point converter 320, a second operation-switching multiplexer 321, a third operation-switching multiplexer 322, multiplexers 323, 324, 325, 327, a subtractor 326, and a register unit 328.

The floating-point to fixed-point converter 320 is connected to the subtractor 313 to receive the first subtractor output I_{y}, and converts the first subtractor output I_{y} from the floating-point format into a fixed-point format, thereby obtaining an approximation calculation result y.

The second operation-switching multiplexer 321 receives a control signal S₂ (e.g., from a controller, a processor, or the like, not shown), is connected to the register unit 328 to receive a register data yₙ, and is connected to the floating-point to fixed-point converter 320 to receive the approximation calculation result y that serves as the initial estimated value y₀ of the inverse square root or reciprocal of the positive integer x. The second operation-switching multiplexer 321 is configured to output the register data yₙ as a second multiplexer output in response to the control signal S₂ being at a first logic level, and to output the approximation calculation result y₀ as the second multiplexer output in response to the control signal S₂ being at a second logic level that is different from the first logic level. In this embodiment, the first logic level is “0”, and the second logic level is “1”, but this disclosure is not limited in this respect. It is noted that the control signal S₂ is configured to be at the second logic level only during the first iterative operation of the refining calculation module 32, and to be at the first logic level for every subsequent iterative operation. The number of the iterative operation(s) of the refining calculation module 32 is adjustable, depending on the required accuracy of the estimated value of the inverse square root or reciprocal of the positive integer x.

The third operation-switching multiplexer 322 receives the mode select signal S₁ and a constant of 1, and is connected to the second operation-switching multiplexer 321 to receive the second multiplexer output. The third operation-switching multiplexer 322 is configured to output the second multiplexer output as a third multiplexer output in response to the mode select signal S₁ indicating the ISR operation, and to output the constant of 1 as the third multiplexer output in response to the mode select signal S₁ indicating the reciprocal operation.

The multiplier 323 is connected to the third constant-select multiplexer 23 to receive the third output constant, is connected to the second operation-switching multiplexer 321 to receive the second multiplexer output, and is configured to multiply the third output constant and the second multiplexer output, thereby obtaining a first multiplier output.

The multiplier 324 receives the positive integer x, is connected to the third operation-switching multiplexer 322 to receive the third multiplexer output, and is configured to multiply the positive integer x and the third multiplexer output, thereby obtaining a second multiplier output.

The multiplier 325 is connected to the multiplier 323 to receive the first multiplier output, is connected to the multiplier 324 to receive the second multiplier output, and is configured to multiply the first multiplier output and the second multiplier output, thereby obtaining a third multiplier output.

The subtractor 326 is connected to the second constant-select multiplexer 22 to receive the second output constant, is connected to the multiplier 325 to receive the third multiplier output, and is configured to subtract the third multiplier output from the second output constant, thereby obtaining a second subtractor output.

The multiplier 327 is connected to the subtractor 326 to receive the second subtractor output, is connected to the second operation-switching multiplexer 321 to receive the second multiplexer output, and is configured to multiply the second subtractor output and the second multiplexer output, thereby obtaining a fourth multiplier output.

The register unit 328 is connected to the multiplier 327 to receive and store the fourth multiplier output as a refined calculation result yₙ₊₁, is connected to the second operation-switching multiplexer 321, and is configured to output the refined calculation result yₙ₊₁ as the register data y, for use by the next iterative operation of the refining calculation module 32. As a result, the refined calculation result yₙ₊₁ is the latest estimated value of the inverse square root of the positive integer x when the mode select signal S₁ indicates the ISR operation, and is the latest estimated value of the reciprocal of the positive integer x when the mode select signal S₁ indicates the reciprocal operation.

In the second embodiment, not only the subtractor 313 but also the multipliers 323, 324, 325, 327 and the subtractor 326 are used in both of the ISR operation and the reciprocal operation, thereby achieving high area efficiency of the circuit structure.

In accordance with some embodiments, the subtractors 313, 326 may be implemented using a single subtractor, with their respective subtraction operations being performed in a time-division manner. In accordance with some embodiments, some or all of the multipliers 323, 324, 325, 327 may be implemented using a single multiplier, with their respective multiplication operations being performed in a time-division manner. Using one arithmetic unit to perform multiple arithmetic operations in the time-division manner can further reduce circuit area.

In summary, the embodiments of this disclosure include one or more arithmetic units (e.g., the subtractors 313, 326 and the multipliers 323, 324, 325, 327) that are used in the elementary arithmetic operations of both of the ISR operation and the reciprocal operation, thereby achieving high area efficiency of the circuit structure and reducing material costs. In addition, this disclosure employs only elementary arithmetic operations to obtain the inverse square root and the reciprocal of a positive integer with high accuracy, thereby increasing hardware computation efficacy with low energy consumption. These advantages favor the promotion of AI computational ability on edge devices.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A circuit structure adapted to switch between inverse square root (ISR) operation and reciprocal operation, comprising:
a register module storing at least one ISR operation constant and at least one reciprocal operation constant;
a multiplexer module electrically connected to said register module to receive the at least one ISR operation constant and the at least one reciprocal operation constant, disposed to receive a mode select signal that indicates one of the ISR operation and the reciprocal operation, and configured to deliver a multiplexer constant output, wherein the multiplexer constant output is the at least one ISR operation constant in response to the mode select signal indicating the ISR operation, and is the at least one reciprocal operation constant in response to the mode select signal indicating the reciprocal operation; and
an operation circuit disposed to receive a positive integer and the mode select signal, and electrically connected to said multiplexer module for receiving the multiplexer constant output;
wherein the operation circuit is configured to, in response to the mode select signal indicating the ISR operation, perform a first set of elementary arithmetic operations on the positive integer using the multiplexer constant output that is the at least one ISR operation constant, thereby obtaining an estimated value of an inverse square root of the positive integer;
wherein said operation circuit is configured to, in response to the mode select signal indicating the reciprocal operation, perform a second set of elementary arithmetic operations on the positive integer using the multiplexer constant output that is the at least one reciprocal operation constant, thereby outputting an estimated value of a reciprocal of the positive integer; and
wherein the operation circuit includes at least one arithmetic unit that is used in both of the first set of elementary arithmetic operations and the second set of elementary arithmetic operations.

2. The circuit structure as claimed in claim 1, wherein the at least one reciprocal operation constant includes a first reciprocal operation constant equaling 2(B−σ)L, where B represents an exponent bias of a floating-point format, σ is a constant with a value of 0.0450465, L is equal to 2ⁿ, and n is a number of mantissa bits in the floating-point format;
wherein said operation circuit includes:
a converter disposed to receive the positive integer, and configured to convert the positive integer into the floating-point format, thereby obtaining a floating-point number; and
a subtractor disposed to receive the floating-point number and the first reciprocal operation constant when the mode select signal indicates the reciprocal operation, and configured to subtract the floating-point number from the first reciprocal operation constant by treating the floating-point number as if the floating-point number were a binary integer, thereby obtaining an approximation of the reciprocal of the positive integer in the floating-point format; and
wherein said operation circuit is configured to obtain the estimated value of the reciprocal of the positive integer based on the approximation of the reciprocal of the positive integer.

3. The circuit structure as claimed in claim 2, wherein the at least one ISR constant includes a first ISR operation constant equaling 3/2(B−σ)L;
wherein said multiplexer module includes a constant-select multiplexer disposed to receive the mode select signal, connected to said register module to receive the first ISR operation constant and the first reciprocal operation constant, and configured to output the first ISR operation constant as a constant output in response to the mode select signal indicating the ISR operation, and to output the first reciprocal operation constant as the constant output in response to the mode select signal indicating the reciprocal operation;
wherein said operation circuit includes an operation-switching multiplexer disposed to receive the mode select signal, connected to said converter to receive the floating-point number and a binary integer number, and configured to output the binary integer number as a multiplexer output in response to the mode select signal indicating the ISR operation, and to output the floating-point number as the multiplexer output in response to the mode select signal indicating the reciprocal operation, where the binary integer number equals a binary value of right-shifting the floating-point number by one bit;
wherein said subtractor is connected to said constant-select multiplexer to receive the constant output, is connected to said operation-switching multiplexer to receive the multiplexer output, and is configured to subtract the multiplexer output from the constant output using fixed-point arithmetic, thereby obtaining the approximation of the reciprocal of the positive integer in the floating-point format when the mode select signal indicates the reciprocal operation, and obtaining an approximation of the inverse root square of the positive integer in the floating-point format when the mode select signal indicates the ISR operation; and
wherein said operation circuit is configured to obtain the estimated value of the inverse root square of the positive integer based on the approximation of the inverse root square of the positive integer.

4. The circuit structure as claimed in claim 1, wherein said operation circuit includes an approximation calculation module and a refining calculation module;
wherein the at least one ISR operation constant includes a plurality of ISR operation constants, a first part of which is for use by said approximation calculation module, and a second part of which is for use by said refining calculation module;
wherein the at least one reciprocal operation constant includes a plurality of reciprocal operation constants, a first part of which is for use by said approximation calculation module, and a second part of which is for use by said refining calculation module;
wherein said approximation calculation module is disposed to receive the positive integer, and is configured to calculate an approximation of the inverse square root of the positive integer based on the first part of the plurality of ISR operation constants in response to the mode select signal indicating the ISR operation, and to calculate an approximation of the reciprocal of the positive integer based on the first part of the plurality of reciprocal operation constants in response to the mode select signal indicating the reciprocal operation;
wherein said refining calculation module is connected to said approximation calculation module for receiving the approximation of the inverse square root of the positive integer when the mode select signal indicates the ISR operation, and for receiving the approximation of the reciprocal of the positive integer when the mode select signal indicates the reciprocal operation;
wherein said refining calculation module is configured to refine the approximation of the inverse square root of the positive integer based on the second part of the plurality of ISR operation constants in response to the mode select signal indicating the ISR operation, thereby outputting the estimated value of the inverse square root of the positive integer; and
wherein said refining calculation module is configured to refine the approximation of the reciprocal of the positive integer based on the second part of the plurality of reciprocal operation constants in response to the mode select signal indicating the reciprocal operation, thereby outputting the estimated value of the reciprocal of the positive integer.

5. The circuit structure as claimed in claim 4, wherein said refining calculation module includes at least one of a subtractor or a multiplier that is used in both of calculating the estimated value of the inverse square root of the positive integer, and calculating the estimated value of the reciprocal of the positive integer.

6. The circuit structure as claimed in claim 4, wherein the plurality of reciprocal operation constants include a first reciprocal operation constant equaling 2(B−σ)L, where B represents an exponent bias of a floating-point format, σ is a constant with a value of 0.0450465, L is equal to 2ⁿ, and n is a number of mantissa bits in the floating-point format;
wherein the plurality of ISR constants include a first ISR operation constant equaling 3/2(B−σ)L;
wherein said multiplexer module includes a first constant-select multiplexer disposed to receive the mode select signal, connected to said register module to receive the first ISR operation constant and the first reciprocal operation constant, and configured to output the first ISR operation constant as a first output constant in response to the mode select signal indicating the ISR operation, and to output the first reciprocal operation constant as the first output constant in response to the mode select signal indicating the reciprocal operation;
wherein said approximation calculation module includes:
a first converter disposed to receive the positive integer, and configured to convert the positive integer into the floating-point format, thereby obtaining a floating-point number;
a first operation-switching multiplexer disposed to receive the mode select signal, connected to said first converter to receive the floating-point number and a binary integer number, and configured to output the binary integer number as a first multiplexer output in response to the mode select signal indicating the ISR operation, and to output the floating-point number as the first multiplexer output in response to the mode select signal indicating the reciprocal operation, where the binary integer number equals a binary value of right-shifting the floating-point number by one bit; and
a first subtractor connected to said first constant-select multiplexer to receive the first output constant, connected to said first operation-switching multiplexer to receive the first multiplexer output, and is configured to subtract the first multiplexer output from the first output constant using fixed-point arithmetic, thereby obtaining the approximation of the reciprocal of the positive integer in the floating-point format that serves as a first subtractor output when the mode select signal indicates the reciprocal operation, and obtaining an approximation of the inverse root square of the positive integer in the floating-point format that serves as the first subtractor output when the mode select signal indicates the ISR operation.

7. The circuit structure as claimed in claim 6, wherein the plurality of ISR operation constants include a second ISR operation constant equaling 3/2, and a third ISR operation constant equaling ½, and the plurality of reciprocal operation constants include a second reciprocal operation constant equaling 2, and a third reciprocal operation constant equaling 1;
wherein said multiplexer module includes:
a second constant-select multiplexer disposed to receive the mode select signal, connected to said register module to receive the second ISR operation constant and the second reciprocal operation constant, and configured to output the second ISR operation constant as a second output constant in response to the mode select signal indicating the ISR operation, and to output the second reciprocal operation constant as the second output constant in response to the mode select signal indicating the reciprocal operation; and
a third constant-select multiplexer disposed to receive the mode select signal, connected to said register module to receive the third ISR operation constant and the third reciprocal operation constant, and configured to output the third ISR operation constant as a third output constant in response to the mode select signal indicating the ISR operation, and to output the third reciprocal operation constant as the third output constant in response to the mode select signal indicating the reciprocal operation; and
wherein said refining calculation module includes:
a second converter connected to said first subtractor to receive the first subtractor output, and configured to convert the first subtractor output from the floating-point format into a fixed-point format, thereby obtaining an approximation calculation result;
a second operation-switching multiplexer disposed to receive a control signal and a register data, connected to said second converter to receive the approximation calculation result, and configured to output the register data as a second multiplexer output in response to the control signal being at a first logic level, and to output the approximation calculation result as the second multiplexer output in response to the control signal being at a second logic level that is different from the first logic level;
a third operation-switching multiplexer disposed to receive the mode select signal and a constant of 1, connected to said second operation-switching multiplexer to receive the second multiplexer output, and configured to output the second multiplexer output as a third multiplexer output in response to the mode select signal indicating the ISR operation, and to output the constant of 1 as the third multiplexer output in response to the mode select signal indicating the reciprocal operation;
a first multiplier connected to said third constant-select multiplexer to receive the third output constant, connected to said second operation-switching multiplexer to receive the second multiplexer output, and configured to multiply the third output constant and the second multiplexer output, thereby obtaining a first multiplier output;
a second multiplier disposed to receive the positive integer, connected to said third operation-switching multiplexer to receive the third multiplexer output, and configured to multiply the positive integer and the third multiplexer output, thereby obtaining a second multiplier output;
a third multiplier connected to said first multiplier to receive the first multiplier output, connected to said second multiplier to receive the second multiplier output, and configured to multiply the first multiplier output and the second multiplier output, thereby obtaining a third multiplier output;
a second subtractor connected to said second constant-select multiplexer to receive the second output constant, connected to said third multiplier to receive the third multiplier output, and configured to subtract the third multiplier output from the second output constant, thereby obtaining a second subtractor output;
a fourth multiplier connected to said second subtractor to receive the second subtractor output, connected to said second operation-switching multiplexer to receive the second multiplexer output, and configured to multiply the second subtractor output and the second multiplexer output, thereby obtaining a fourth multiplier output; and
a register unit connected to said fourth multiplier to receive and store the fourth multiplier output as a refined calculation result, connected to said second operation-switching multiplexer, and configured to output the refined calculation result as the register data, where the refined calculation result serves as the estimated value of the inverse square root of the positive integer when the mode select signal indicates the ISR operation, and serves as the estimated value of the reciprocal of the positive integer when the mode select signal indicates the reciprocal operation.
